(19) United States
(12) Patent Application Publication
(10) Pub. No.: US 2023/0162203 A1
(43) Pub. Date: May 25, 2023

(54) EMISSIONS RECORDS LEDGER FOR CORRELATED EMISSION ANALYTICS

(71) Applicant: Microsoft Technology Licensing, LLC, Redmond, WA (US)

(72) Inventor: Mehmet Kadri UMAY, Redmond, WA (US)

(73) Assignee: Microsoft Technology Licensing, LLC, Redmond, WA (US)

(21) Appl. No.: 17/657,098

(22) Filed: Mar. 29, 2022

Related U.S. Application Data
(60) Provisional application No. 63/264,570, filed on Nov. 24, 2021.

(51) Int. Cl. G06Q 30/00; G06Q 50/30

(52) U.S. Cl. CPC G06Q 30/018; G06Q 50/30; G06Q 2220/00

(57) ABSTRACT

A computing system is configured to receive a plurality of emission data records from a plurality of emission reporting devices corresponding to a plurality of different emission reporting entities. The emission data records are stored in an emission records ledger. A request for correlated emission analytics is received from a requesting device. A correlation is identified between two or more emission data records. The correlated emission analytics are transmitted to the requesting device based at least in part on the identified correlation.

### CROSS REFERENCE TO RELATED APPLICATIONS

This application claims priority to U.S. Provisional Patent Application No. 63/264,570, filed Nov. 24, 2021, the entirety of which is hereby incorporated herein by reference for all purposes.

### BACKGROUND

In some cases, it is mandatory for companies, organizations, governments, individuals, and/or other entities to track the greenhouse gas (GHG) emissions for which they are responsible—e.g., to comply with applicable regulations. Greenhouse gases can include, as examples, carbon dioxide (CO2); methane (CH4); fluorocarbons and other fluorinated gases (e.g., hydrofluorocarbons, perfluorocarbons), nitrous oxide (N2O), etc. Entities may track their GHG emissions in an attempt to understand and reduce their carbon footprint, to evaluate their compliance with emissions regulations, to fulfill contractual obligations, and/or for any other reason.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing system is configured to receive a plurality of emission data records from a plurality of emission reporting devices corresponding to a plurality of different emission reporting entities. The emission data records are stored in an emission records ledger. A request for correlated emission analytics is received from a requesting device. A correlation is identified between two or more emission data records. The correlated emission analytics are transmitted to the requesting device based at least in part on the identified correlation.

### BRIEF DESCRIPTION OF THE DRAWINGS

FIGS. 1A and 1B schematically illustrate different emission reporting entities providing emission data records to an emission records ledger.

FIG. 2 illustrates an example method for emission records analytics.

FIGS. 3A and 3B schematically illustrate use of a distributed blockchain to implement an emission records ledger.

FIG. 4 schematically illustrates an emission records ledger receiving emission data records.

FIG. 5 schematically illustrates transmitting correlated emission analytics to a requesting entity.

FIG. 6 schematically shows an example computing system.

### DETAILED DESCRIPTION

While entities are often capable of tracking the greenhouse gas (GHG) emissions they are directly responsible for—e.g., calculated based on the amount of fossil fuels they consume—it can be difficult for entities to quantify the emissions for which they may be indirectly responsible. As one example, a construction company involved in the construction of a new building may order cement from a cement factory. The construction company may indirectly be responsible for some amount of GHG emissions associated with the cement order. For instance, the cement factory emits GHGs in producing the order, and one or more transportation/shipping companies emit GHGs in transporting the order. However, the construction company will typically have limited insight into the emissions produced by the various other entities involved in facilitating the cement order, which can complicate efforts to determine the overall carbon footprint associated with the construction project.

Accordingly, the present disclosure is directed to an emission records ledger that may enable different entities to evaluate the emissions for which they are responsible, both directly and indirectly, by correlating different emission records provided by different emission reporting entities. To reuse the above example, the construction company, cement factory, transportation/shipping companies, and/or any other entities involved in facilitating the cement order may each provide emission data records to the emission records ledger. A correlation service may identify a correlation between two or more different emission data records to determine correlated emission analytics, and the correlated emission analytics can then be provided to a requesting entity based at least in part on the identified correlation. For example, the correlated emission analytics may be used by the construction company to quantify the total amount of emissions associated with the cement order, so that it can be counted as part of the construction company's overall carbon footprint, and/or as part of a carbon budget associated with construction of the building.

The emission records ledger may therefore beneficially enable tracking of GHG emissions in a manner that is transparent, standardized, and auditable, as will be described in more detail below. In particular, the techniques described herein may provide a technical benefit of providing a new and improved system for aggregation, correlation, and retrieval of information relating to GHG emissions by disparate entities. Furthermore, the techniques described herein may provide a technical benefit of improving human-computer interaction by reducing the complexity associated with any particular entity determining their emissions responsibility, even when this includes emissions reported separately by different entities.

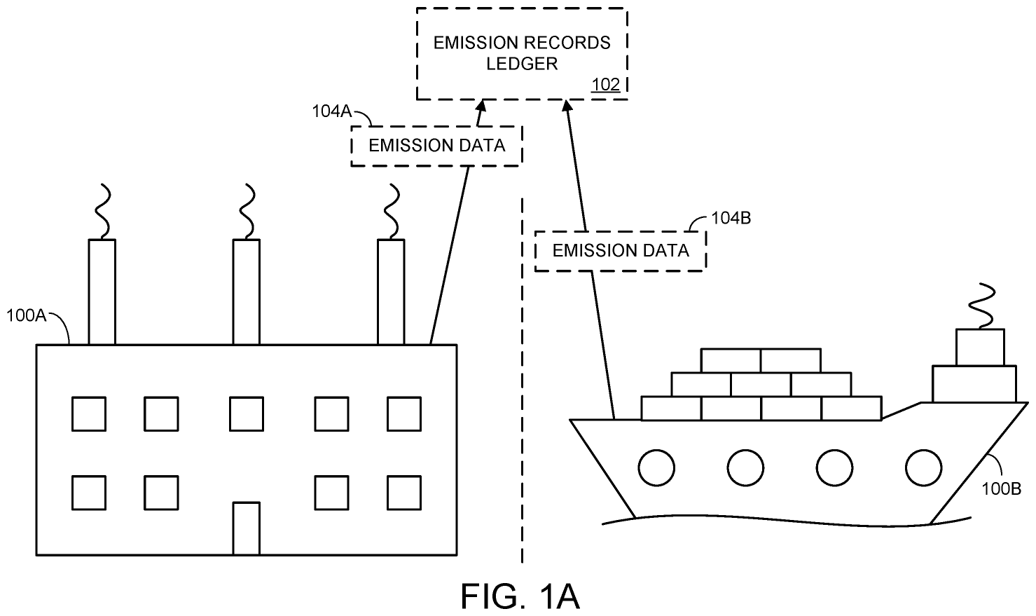

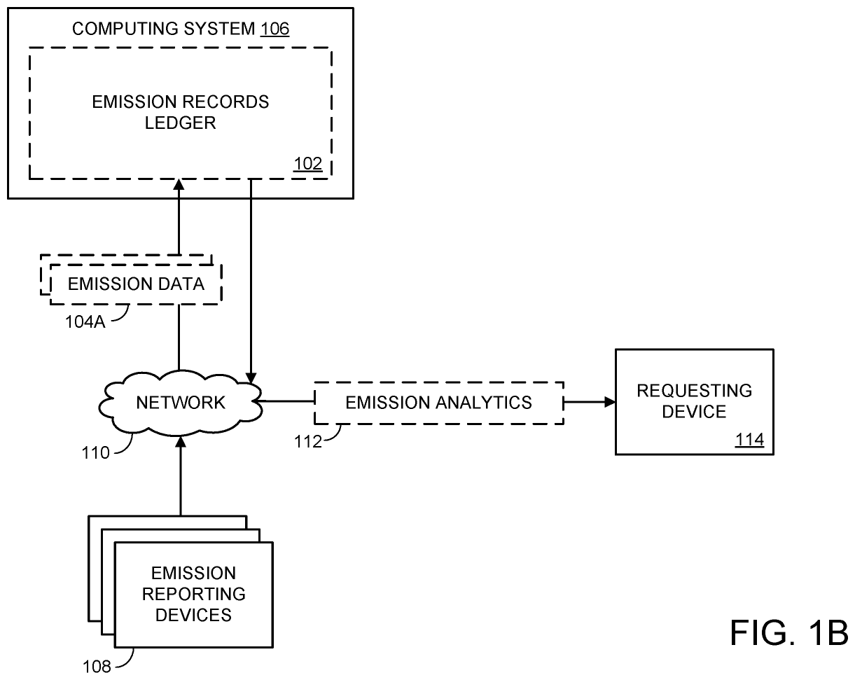

FIGS. 1A and 1B schematically illustrate reporting of emissions data to an emission records ledger by different emission reporting entities. Specifically, FIG. 1A schematically represents two different emission reporting entities 100A and 100B, where entity 100A includes a factory and entity 100B includes a cargo ship. However, it will be understood that an “emission reporting entity” as described herein can take the form of any person, organization, company, government agency, and/or other party involved in activity that causes GHG emissions, and that provides emission data records to an emission records ledger.

As will be described in more detail below, the emission data records may be reported by emission reporting devices, taking the form of suitable computing devices corresponding to the different emission reporting entities. For example, emission data records may be reported by entity 100A via one or more computing devices controlled by the same owner or operator of the factory. Such computing devices may be located within the factory, or may have any suitable location outside of the factory—e.g., the operator of the factory may aggregate emissions data from multiple different factories at an emission reporting device taking the form of a server computer located in a data center.

As shown in FIG. 1A, emission reporting entities 100A and 100B each report emissions data records 104A/104B to an emission records ledger 102. An “emissions data record” generally includes some information pertaining to actual or potential GHG emissions responsibility of the reporting entity. For instance, an emission data record may specify the estimated amount of GHGs emitted by the reporting entity—e.g., expressed in carbon dioxide equivalents (CO2e). Such emissions may be associated with a particular period of time (e.g., one day, one month, one year), associated with a particular event (e.g., a transaction, a construction project, development of a new product), and/or any other suitable categorization of emissions activity may be used.

Additionally, or alternatively, an emission data record may specify activity data relating to an activity associated with emission of GHGs, without including a numerical estimate of the amount of GHGs emitted. For example, entity 100A may report the total amount of electrical power consumed over some interval of time. This may be converted into an estimated amount of GHG emissions caused by the activity of the emission reporting entity—e.g., via a conversion service associated with the emission records ledger. For example, the electrical power consumption reported by the entity may be converted into an estimated amount of GHG emissions based at least in part on information regarding the source of the power (e.g., whether a local power plant supplying the factory burns coal, natural gas, and/or uses other suitable power sources).

As another example, an emission data record may specify information relating to an activity or event (such as a transaction) for which the associated GHG emissions are unknown. As will be described in more detail below, such an emission data record may be correlated with other emission data records (e.g., provided by other emission reporting entities) to estimate the actual GHG emissions associated with the activity. To use the example from above, the construction company may provide an emission data record specifying that it purchased a quantity of cement from a cement factory. This may be correlated with emission data records provided by the cement factory to estimate the GHG emissions inherited by the construction company due to the cement order.

In any case, emission data records may in some cases include supplementary data that provides more information or context as to the emissions activity being reported. For example, an emission data record may include unique identifiers corresponding to the reporting entity, one or more other related entities, one or more transactions associated with the emission data record (e.g., a unique transaction identifier), and/or a physical product associated with the emission data record (e.g., a unique product serial number). As additional examples, an emission data record may specify a product order quantity (e.g., ten units, fifty kilograms, twelve liters), a location at which the emissions activity occurred, the date on which a transaction occurred, etc. Such information may be included with or appended to an emission data record in any suitable way—e.g., as metadata.

An emission data record may use a plurality of different data fields to store such supplementary information. For example, an emission data record may include a data field corresponding to an identifier of the emission reporting entity that provided the record, one or more data fields corresponding to other emission reporting entities relevant to the record (e.g., in the context of a transaction involving two or more entities), one or more data fields for storing unique transaction identifiers, unique product serial numbers, product order quantities, location information, time and date information, etc. In some cases, different emission reporting entities provided by different emission reporting entities may each use a standardized format to facilitate easier correlation. In other cases, one or more emission reporting entities may report emission data using non-standard formats, and the emission data may be standardized by the emission records ledger (and/or one or more supporting services) upon receipt (e.g., via template translators or previously-trained machine learning models).

In general, however, each emission data record may include virtually any suitable information pertaining to an entity's emission of GHGs, and such information may be organized and/or formatted using any suitable data structure(s), schemas, file format and/or encodings. Furthermore, an application programming interface (API) or other software interface may be established for efficiently sending/receiving emission data records.

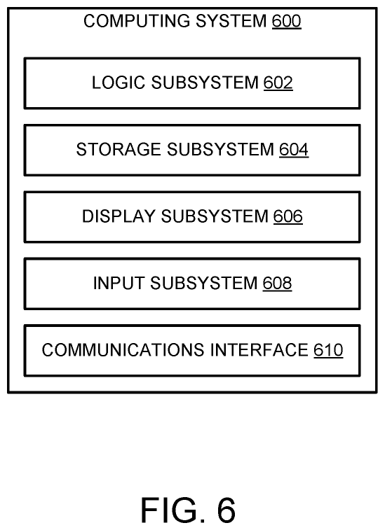

FIG. 1B schematically illustrates reporting of emission data records in more detail. Specifically, FIG. 1B again shows emission records ledger 102, implemented by an example computing system 106. Computing system 106 may be implemented by any suitable combination of one or more computing devices. Any computing device(s) implementing computing system 106 may have any suitable capabilities, hardware configuration, and form factor. In some cases, computing system 106 may be implemented as computing system 600 described below with respect to FIG. 6.

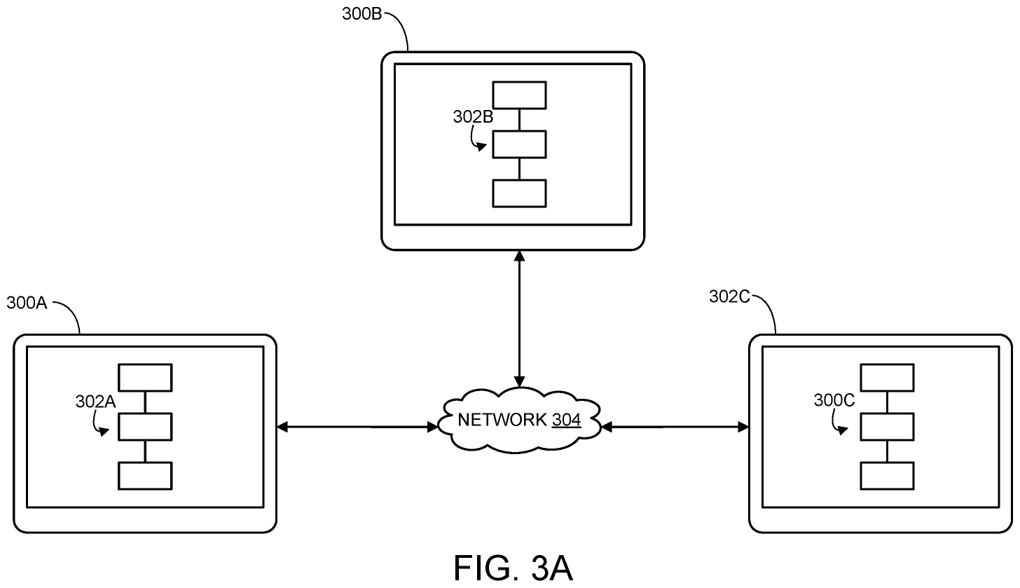

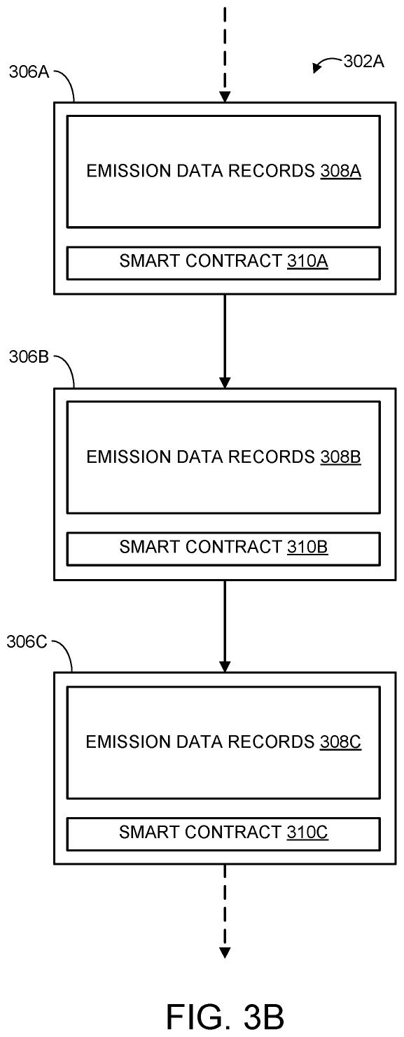

In general, the emission records ledger may take the form of a centralized or distributed database of emission records and/or transaction data provided by a plurality of different emission reporting devices. Specific details regarding the emission records ledger will be given below with respect to FIGS. 3A-5. As shown in FIG. 1B, a plurality of different emission reporting devices 108 transmit emission data records, including emission data record 104A, to computing system 106 over a network 110.

An “emission reporting device” generally refers to any suitable computing device used to provide emission data records to an emission records ledger. In some cases, the same emission reporting entity (e.g., individual, company, organization, government agency) may be associated with two or more different emission reporting devices. As such, though only three emission reporting devices are depicted in FIG. 1B, it will be understood that any suitable number of different emission reporting devices, corresponding to any suitable number of different emission reporting entities, may provide emission data records to the emission records ledger. As with computing system 106, each emission reporting device may have any suitable capabilities, hardware configuration, and form factor. Furthermore, an emission reporting device may be implemented as computing system 600 described below with respect to FIG. 6.

Though only two emission data records are schematically depicted in FIG. 1B, it will be understood that each different emission reporting entity may provide any suitable number of different emission data records to the emission records ledger. In other words, each emission reporting entity may be associated with any suitable number of different emission reporting devices, which may each transmit any suitable number of different emission data records to the emission records ledger.

Network 110 may be implemented as any suitable computer network. Network 110 may comprise any suitable number of different computer networking devices—e.g., routers, switches, relays. Network 110 may be implemented as a local-area network (e.g., an on-premises network), and/or network 110 may be implemented as a wide-area network such as the Internet.

Furthermore, in FIG. 1B, computing system 106 transmits correlated emission analytics 112 over computer network 110 to a requesting device 114 corresponding to a requesting entity. As will be described in more detail below, this may include correlating two or more different emission data records—e.g., by determining that the records relate to one or more transactions between two emission reporting entities, such as a purchase of cement as discussed above. In general, however, the correlated emission analytics may take any suitable form, and may be based on an analysis of any or all of the information stored in the emission records ledger. As more such data is stored, more correlations can be made, thus making GHG tracking and reporting more accurate and complete. It is believed that the utility of the GHG emissions tracking and reporting will increase in proportion to an increasing number of entities that supply GHG emission data and in proportion to the percentage of GHG emission activity that each such entity reports.

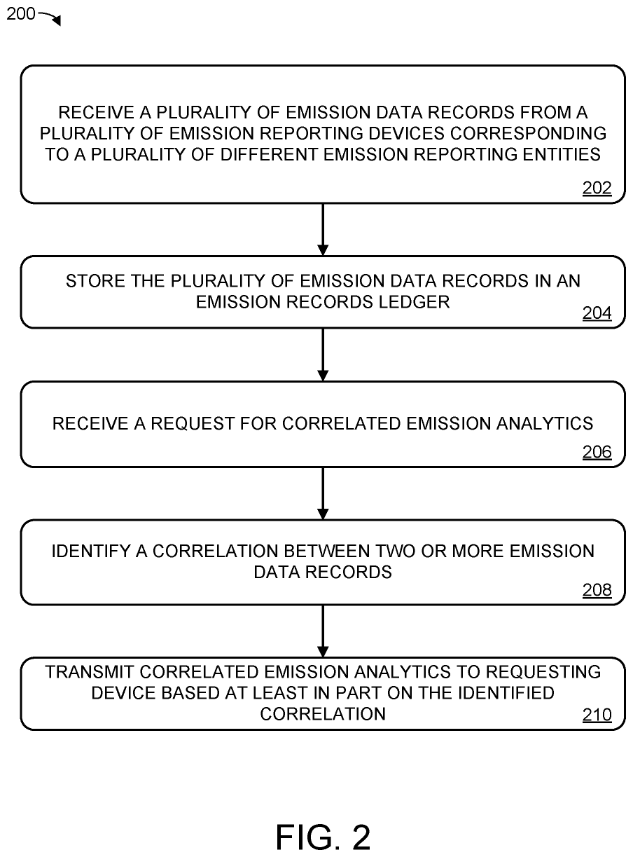

FIG. 2 illustrates an example method 200 for emission records analytics. Method 200 may be implemented by any suitable computing system of one or more computing devices. Any computing device implementing method 200 may have any suitable capabilities, hardware configuration, and form factor. In some cases, method 200 may be implemented by computing system 106 described above with respect to FIGS. 1A and 1B. In some cases, method 200 may be implemented by computing system 600 described below with respect to FIG. 6.

At 202, method 200 includes receiving a plurality of emission data records from a plurality of emission reporting devices. The emission reporting devices correspond to a plurality of different emission reporting entities. This is described above with respect to FIGS. 1A and 1B, where computing system 106 receives emission data records from a plurality of emission reporting devices 108. The emission reporting devices may correspond to any suitable number of different emission reporting entities, such as emission reporting entities 100A and 100B of FIG. 1A.

Continuing with method 200, at 204, the method includes storing the plurality of emission data records in an emission records ledger. As discussed above, the emission records ledger may take the form of any suitable centralized or distributed database useable to store emission data. Thus, the emission data records may be stored and organized in virtually any suitable way, and distributed between any suitable number of different individual computing devices.

In some cases, the emission records ledger may be implemented as a distributed ledger via blockchain technology. In other words, the emission records ledger may be implemented as a blockchain collectively maintained by a plurality of different computing devices. For instance, the emission records ledger 102 may be implemented as a blockchain that is stored by computing system 106, any or all of the emission reporting devices 108, and/or any number of other ledger-keeping devices. This may beneficially improve the security and level of trust associated with the emission records ledger—e.g., use of blockchain technology enables each emission reporting entity to have confidence that the emission records ledger is accurate and that rogue actors cannot manipulate the data, without requiring the entities to trust a single centralized recordkeeper. In other words, blockchain technology can beneficially improve data security without affecting the ability of any given entity to access the data.

FIGS. 3A and 3B illustrate a scenario where the emission records ledger is implemented via a blockchain. Specifically, FIG. 3A schematically illustrates a plurality of computing devices 300A, 300B, and 300C collectively maintaining a blockchain over a network 304, where each device 300A-C maintains its own respective copy 302A-C of the blockchain. Each computing device may include a communications interface configured to communicatively couple the plurality of computing devices over the network. The computing devices maintaining copies of the blockchain may each have any suitable hardware configuration and form factor. As examples, a blockchain computing device may take the form of a desktop computer, laptop, server, mobile device (e.g., smartphone, tablet), wearable device, media center, etc. In some examples, computing devices 300A-300C may be implemented as computing system 600 described below with respect to FIG. 6.

Only three computing devices are shown in FIG. 3A. However, this is for illustration purposes only. In practical usage, a blockchain may be collectively maintained by any number and variety of computing devices. Such computing devices may be separated by any physical distance and may communicate over any suitable network, including private networks, public networks such as, for example, the Internet, and/or hybrid network environments.

Furthermore, the computing devices may be owned and maintained by any number of different individuals or organizations. In some examples, the blockchain may be publicly accessible, in which substantially anyone can download and maintain a local copy of the blockchain. Alternatively, access to the blockchain may be restricted to known users or parties (e.g., only those who are authorized to provide data to or extract data from the blockchain), in which case the blockchain may be referred to as a “private blockchain.”

Depending on the implementation, devices maintaining the blockchain may use any suitable method to validate the identity of a party submitting a new block. In general, when the blockchain is distributed between two or more different devices, tampering with any particular copy of the blockchain should not affect the blockchain as a whole, as other computing devices maintaining the blockchain will reject the change. Only valid, authorized blocks are approved and added to the chain. This alleviates the need for a central institution to serve as a mediator or recordkeeper. For example, each party authorized to contribute to the blockchain may be assigned a unique digital signature, which can be validated upon receiving a new block—e.g., via private key/public key cryptography. This may beneficially improve the security and transparency of the blockchain, enabling auditing of the blockchain to verify the authenticity of the recorded data.

Because the blockchain is collectively maintained by the plurality of computing devices, each local copy of the blockchain should be substantially identical in typical usage. Should any particular computing device determine that the blockchain should be changed (e.g., by adding a new block), it may transmit a proposed update to the other computing devices in the plurality. Depending on the implementation, this proposed update may take a variety of suitable forms, and may be evaluated for compliance by other computing devices of the plurality before incorporation into the blockchain. Assuming the proposed update is compliant, the other computing devices of the plurality may incorporate the proposed update into their local copies of the blockchain, meaning each local copy will continue to be substantially identical. If the proposed update is non-compliant (e.g., because it includes fraudulent information), then the other computing devices may reject its addition to the blockchain. In this manner, each party associated with the blockchain can be confident that any particular copy of the blockchain they access will reflect an overall consensus.

FIG. 3B schematically represents a particular copy 302A of the blockchain in more detail. In this example, blockchain copy 302A includes a plurality of blocks, including three blocks labeled as 306A-306C. However, it will be understood that this is not limiting, and that a blockchain may include any arbitrary number of blocks.

Depending on the implementation, each block in the blockchain can include any variety of suitable information. In some cases, each block may include a header, which may include a hash of one or more previous blocks in the chain. A hash can be described as a unique “fingerprint” of a piece of digital information and can be calculated using a variety of suitable hashing algorithms, including MD5 and SHA-256 as nonlimiting examples. Inclusion of prior block hashes serves to validate the sequence of blocks in the chain, as each block should be succeeded by a block including a corresponding hash value, and also provides a defense against modifications to the chain, as even minor changes to a block will affect its hash value. In some cases, each block may utilize a corresponding “proof-of-work” or “proof-of-stake” paradigm for authentication and consensus.

Furthermore, as shown, each block 306A-306C includes corresponding sets of emission data records 308A-308C. Each set of emission data records may include any suitable number of individual records, formatted and organized using any suitable data structure(s), schemas, file format and/or encodings.

In FIG. 3B, each block further includes one or more smart contracts 310A-310C. A smart contract is a computing object programmed to automatically perform certain actions when previously-specified events occur. For example, when predetermined conditions are met, a smart contract can perform transactions (e.g., reads and writes) that can modify the state of the smart contract and/or trigger events that can be monitored by external entities. As will be described in more detail below, an emission records ledger may in some cases be associated with one or more supporting services (e.g., a correlation service, a conversion service), which can be implemented via one or more blockchain smart contracts.

On a technical level, a smart contract may be implemented as computer code defined by one or more data entries within one or more blocks in a blockchain. Such computer code may be written in any suitable coding language, depending on the specific implementation. Because the blockchain is distributed between a plurality of computing devices, the computer code comprising the smart contract may run on any of the plurality of devices, or on all devices. In a typical example, one or more devices of the plurality will receive some indication (e.g., the current state of a variable) that pertains to the smart contract, causing the smart contract to execute.

Though the present disclosure focuses on a scenario in which the smart contracts are stored and executed in blocks of a blockchain (i.e., “on-chain”), various “off-chain” scenarios are also within the scope of this disclosure. In other words, the smart contract may run and execute on a computing device that monitors the blockchain, although does not maintain a local copy. As one example, a dedicated computing system may store and execute the smart contract, as well as monitor conditions relevant to the smart contract—e.g., emission reporting status. Nevertheless, upon determining that a relevant condition has been satisfied, the computing device may request an update to the blockchain (e.g., via an API).

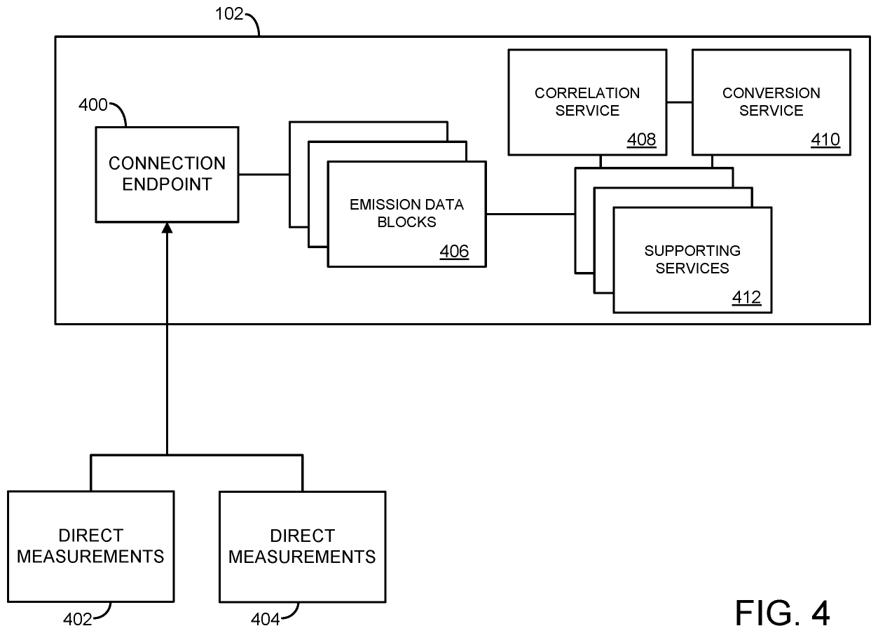

FIG. 4 schematically depicts an example implementation of emission records ledger 102. As discussed above, the emission records ledger may be maintained by any suitable computing system of one or more computing devices. As one example, the ledger may be implemented as a centralized ledger—e.g., using a client/server model. As another example, the ledger may be implemented as a distributed ledger—e.g., via distributed blockchain technology, as described above.

As shown, the emission records ledger includes at least one connection endpoint 400, from which the emission records ledger may receive data from, and/or transmit data to, any of a plurality of emission reporting entities and/or other relevant parties. In the example of FIG. 4, the connection endpoint receives direct emissions measurements 402, and/or indirect emissions measurements 404, from one or more emission reporting entities. A “direct” emission measurement may specify an actual volume of GHG emissions—e.g., expressed in carbon dioxide equivalents (CO2e). By contrast, an “indirect” emission measurement may include information useable to estimate the actual amount of GHG emissions associated with a particular activity—e.g., expressed as an amount of fossil fuel consumed, electrical power used, details regarding a transaction in which a physical good transferred ownership, or information regarding the size of a building (which can be used to estimate GHG emissions based on any suitable methods, e.g., standard formulas correlating square footage with heating/cooling requirements, typical power usage, etc.). Direct and indirect emissions measurements may also be referred to as emission data records, as used elsewhere throughout the present disclosure.

The connection endpoint may receive emission data records from any suitable parties—e.g., any of a plurality of emission reporting entities. Additionally, or alternatively, the connection endpoint may receive transaction data pertaining to transactions between different entities. For example, the connection endpoint may interface, via an application-programming interface (API), with a separate database, such as the petroleum industry data exchange (PIDX), as one non-limiting example. This may beneficially reduce the risk that the reported emission records may inadvertently be incorrect—e.g., due to misinput by a human user.

In some cases, the connection endpoints may enable two-way data exchange with the emission records ledger. For example, as will be described in more detail below, requesting entities (such as emission reporting entities and/or auditing or regulator entities) may receive correlated emission analytics from the ledger. In some cases, access to data from the ledger may be restricted only to parties that have a stake in the data being requested—e.g., to prevent unauthorized dissemination of potentially sensitive emissions data. For instance, in a case where two entities (a first emission reporting entity and a second emission reporting entity) each provide emission data records for a purchase of a physical good, correlated emission analytics may beneficially be restricted only to the first and second entities, to prevent unauthorized disclosure of potentially sensitive information to unrelated parties. In some cases, as is described in more detail below, such correlated emission analytics may additionally be provided to authorized auditors or regulators.

Upon being received at the emission records ledger, the direct and/or indirect emissions measurements received from the plurality of emission reporting entities are stored by the emission records ledger as a plurality of emissions data blocks 406. The data blocks may take any suitable form. In some cases, emissions measurements may be associated with metadata specifying, for example, an entity identifier that provided the measurement; a time at which the measurement was taken or received; a transaction identifier corresponding to a transaction related to the measurement; a serial number corresponding to a product related to the measurement; etc.

The emission data records stored by the emission records ledger may have any suitable scope. In some cases, the emission records ledger may correspond to a particular project—e.g., construction of a building—or the emissions ledger may correspond to an entire industry—e.g., building construction in general. In some cases, the emission ledger may correspond to multiple industries—e.g., substantially any entity in the world that tracks GHG emissions for any reason. In general, the emission records ledger may receive emissions measurements from any number of different entities, located anywhere in the world, and involved in any suitable activities related to GHG emissions.

As shown in FIG. 4, the emission records ledger is associated with various supporting services, including a correlation service 408, a conversion service 410, and a plurality of other supporting services 412. Such services may be performed by the same computing system that maintains the emission records ledger, or one or more of the supporting services may be performed by a different computing device not involved in storing emission data as part of the emission records ledger. In some cases, any or all of the supporting services may be implemented as part of the emission records ledger—e.g., included as part of the computer instructions that instantiate the emission records ledger. Additionally, or alternatively, any or all of the supporting services may be implemented via software that is useable separately from the emission records ledger. It will be understood that the specific services depicted in FIG. 4 are non-limiting, and may be implemented in any suitable way. As one example, any or all of the services depicted in FIG. 4 may utilize “smart contracts” implemented via blockchain technology, as described above.

As will be described in more detail below, correlation service 408 may be useable to identify a correlation between two or more different emission data records. For example, two or more different records provided by two or more different entities may each refer to the same transaction, such as the transfer of ownership of a physical good from one party to another. Thus, for example, emissions associated with the manufacture and transportation of the physical good may be attributed to the new owner. This provides a technical benefit by providing a new and improved system for correlation and retrieval of information relating to GHG emissions—e.g., associated with production of the physical good—and also improves human-computer interaction by reducing the complexity associated with any particular entity determining their emissions responsibility.

As discussed above, conversion service 410 may be useable to output estimated GHG emissions based on suitable activity data reported by an emission reporting entity. For example, an emission reporting entity may provide an emission data record that specifies the amount of electrical power used by the entity over a period of time. The conversion service may be configured to convert the electrical power usage into a corresponding GHG emissions estimate. This may include accessing external information sources—e.g., such as information relating to a local power grid that supplied power to the emission reporting entity. In general, the conversion service may be configured to use any suitable variety of different conversion algorithms and models, and may access any suitable sources of external information, to convert activity data reported by an emission reporting entity into an estimated GHG emission volume.

As one example, the conversion service may be configured to access one or more third-party service providers (e.g., via open APIs maintained by the service providers) that can estimate GHG emissions based at least in part on electrical power usage reported by an emission reporting entity. For instance, such third-party service providers may estimate GHG emissions by collecting data from one or more nearby energy generation facilities, such as data pertaining to the manner in which the facility generates power (e.g., coal- or gas-burning, hydroelectric, geothermal, solar, nuclear, and/or a mix of multiple energy types). Thus, for example, a reported power consumption in kWh may be used to estimate a volume of natural gas burned in generating the power (e.g., 1 m³ of natural gas may generate approximately 10 kWh), and estimate an amount of GHG emissions associated with burning of the natural gas (e.g., burning of 1 m³ of natural gas may release approximately 2.2 kg of CO2).

As another example, estimation of GHG emissions for industries such as cement and steel can be done via different suitable calculation models and standards. For instance, the conversion service may be configured to provide calculated emissions via different models, such as those defined by the WBCSD (World Business council for Sustainable Development) or EPA (Environmental Protection Agency). Additionally, or alternatively, GHG emissions may be estimated by one or more third-party service providers as discussed above. In other words, the conversion service beneficially provides flexibility as to how GHG emissions are estimated, based on the types of information provided by the emission reporting entity.

In some examples, each time the conversion service estimates GHG emissions for an emission reporting entity, the conversion service may generate a unique transaction ID to beneficially provide an auditable trace. The unique transaction ID may map to a log providing information on the value of the inputs, calculation methods, parameters used, and/or any other relevant information.

The various supporting services associated with the emission records ledger, including correlation service 408, conversion service 410, and other supporting services 412, may provide numerous advantages over typical emissions self-reporting. For example, emissions self-reporting is often practiced with no independent emission verification. Such practice can lead to inaccurate and untrustworthy data within the carbon market. By contrast, according to the techniques described herein, services implemented with the emission records ledger (e.g., conversion service 410) may perform emission calculations based on industry standard models, allowing emissions records to be provided to auditors in an immutable ledger. All calculations, and the emissions components, may be visualized by using transaction data in the ledger, which can be correlated to form the carbon footprint for any particular product or project (e.g., constructing a building, assembling a car) using a composition graph.

Furthermore, there exist over 200 methodologies for calculating carbon dioxide emissions. The techniques described herein may beneficially use an open ledger with smart contracts and/or remote services running as oracles on tamper-proof secure enclaves to enable addition of new calculation methods and provide traceability. With the unit conversion services, the calculations may be normalized and provide a standard equivalent carbon footprint across different methodologies. By providing a traceable and auditable environment on an immutable ledger, the ledger may be configured to provide the calculation results, the inputs, and the model parameters to auditors and regulators.

Services associated with the emission records ledger may further be useable to alleviate double counting, referring to entering a record or transaction twice as a single entry. To prevent double counting, emission records may be calculated as they are entered into the system. A custody transfer mechanism, whether through physical metering and/or through supply chain transactions, may be provided to collect the operating inputs and calculate the emissions. Artificial intelligence (AI)-based checkpoints based on historical data or heuristic rules may be provided to prevent double entry and/or attribution of the same carbon emissions. A set of defining profile parameters may be provided for the operator that is entering a transaction. For example, in the case of a forest location or production facility, services of the ledger may calculate permissible measurement ranges based at least on forest acres or production rates, as examples. In this manner, emissions records may be continuously audited as new values are entered into the ledger. Double counting and calculations may be substantially alleviated, as there may be only one entry and one calculation for the emissions footprint for each entity, and this single entry may be used by any downstream entities.

In some examples, the emission records ledger may be configured to evaluate product components (e.g., referring to processes or discrete manufacturing) to build product graphs to calculate the carbon footprint across an entire supply chain. These composition graphs may be implemented as templates, such as the components that constitute a product, or could be instance-based—e.g., Producer X receives energy from provider A, steam from provider C, etc. For example, templates may be generated for different product types, where each template specifies the different components and/or services involved in producing the product—e.g., a template for a car may include entries for car seats, tires, chassis, paint, and other components, as well as services such as human assembly and component transportation. A template may in some cases be implemented as a tree structure, including different levels corresponding to different components, subcomponents, raw materials, etc. For example, a car chassis may comprise various steel parts and fasteners, while the steel parts may further be comprised of raw steel material, and each of these may be recorded in separate levels of the template's tree structure.

In some cases, templates may be derived at least in part from standardized process manufacturing recipes—e.g., compliant with the International Society of Automation (ISA)-88 standard. In any case, use of templates by the emission records ledger may beneficially enable holistic tracking of the emissions attributable to different components of a final product. For example, for each entry in a template, the emission records ledger may store corresponding serial numbers, manufacturing/installation times, manufacturing/installation locations, etc. This may beneficially provide a traceable graph of how the Scope 3 emissions are calculated.

It will be understood that a template may have any suitable granularity. In some examples, the same template may be used for several products, or a general type of product. For instance, a common template may be used for vehicles in general. In another example, specific templates may be used for different types of vehicles—e.g., compact cars, luxury cars, trucks, and sport utility vehicles—as vehicles of a same type (e.g., compact cars) may include similar components even when produced by different manufacturers. As another example, different templates may be used for different specific products—e.g., a particular model of compact car may use one template, while a different model of compact car may use a different template.

Such composition graphs may initially start relatively coarse-grained, relating to an overall product in a facility, while the inputs coming from providers may enable the correlation graphs to be modified into more fine-grained models based on the need. Composition graphs may beneficially be used to traverse different inputs and production cycles to transparently calculate the carbon footprint for any particular entity. Additionally, or alternatively, composition graphs may provide analytics on the impact of supply chain decisions on overall carbon footprints—e.g., composition graphs may allow decisionmakers to evaluate the potential emissions impacts associated with changing different aspects of the supply chain. For example, using a composition graph, an entity may evaluate whether replacing a first producer with a second producer affects their indirect emissions responsibility—e.g., because the second producer uses different upstream transportation providers that contribute to less overall emissions than the first producer. As other examples, composition graphs may enable entities to evaluate whether changing the recipe of a product will affect emissions, or changing the location at which the product is produced will affect emissions. In other words, composition graphs can beneficially provide more insight into how an entity's emissions responsibility may be changed by changing different aspects of the entity's broader supply chain.

Policies to evaluate and calculate composition graphs may be provided via a policy engine of the emission records ledger, where rules can be provided in checking the validity of the calculations—e.g., locations of products, shipments, what are the components that should exist, what are acceptable ranges of carbon emissions for certain components of the products, how do products flow across the supply chain, etc.

In some cases, whenever emissions are published to the ledger, such emissions may be associated with a product ID, which may include some combination of a combination of product type, facility location (e.g., meter location at the grid, or production facility location), and/or a producer ID (e.g., that uniquely defines the producer). The originator may ingest the product ID, the time range, the emissions value (e.g., in the case of a direct measurement), and/or a set of input parameters associated with a model ID and calculation parameters (e.g., in the case of an indirect measurement). This may be recorded in the ledger in an immutable way, and may be exposed to a correlation service associated with the ledger. Any suitable models may be used—e.g., models defined by the EPA and/or the Greenhouse Gas Protocol. A “model ID” refers to a specific version and type of the model used. This beneficially can facilitate consistent and replicable emissions calculations during auditing/review of emissions data. For instance, over time standard models and calculation parameters can change, but because the model ID is recorded, the original model and calculation parameters can be used to consistently replicate the original emissions calculations.

In some cases, the emission records ledger may be self-organizing—e.g., the product graph may be mapped to the components that constitute it. Hence, as soon as a new emissions record is entered into the ledger, the correlation service may associate it with a product type. Products of that specific product type that have still active footprint calculations may be evaluated and the overall footprint calculation may be updated for the product instances that use the newly entered service or product as an input.

Notably, the ledger may be self-organizing in such a way that the emissions to product mappings are generated progressively as data becomes available based on predetermined policies. For instance, the location and time for a generated chemical may be utilized by a higher-level product that uses this chemical in the production process. Manufacturers could also provide and load their product graphs to the ledger, which may enable the emission records ledger to calculate an overall emissions footprint based on the raw material providers' emissions data. In this manner, the full emissions lineage may be traceable to all of the providers that contribute to the product.

In other cases, however, manufacturers may opt not to provide their product graphs to the ledger—e.g., to preserve confidential information and trade secrets. In some cases, the emission records ledger, and/or any or all of the supporting services associated with the emission records ledger, may be hosted in an entity-specific private instance. In this manner, the entity may benefit from use of an emission records ledger without exposing confidential information to a broader audience. Such a private instance may be auditable by authorized regulators/auditors via confidentiality agreements established between the entity and authorized parties.

Furthermore, as discussed above, the emission records ledger may in some cases be distributed between a plurality of different entities—e.g., as a plurality of different private instances that communicate in a secure manner via cryptographic authentication. For example, components of template graphs may reside in different distributed instances—e.g., a car seat manufacturer may maintain a private instance, and provide aggregated emissions data for their car seats to any entities purchasing/transporting/distributing the car seats, without exposing their internal product template to such other entities. Nevertheless, emissions data may be reported with unique transaction identifiers that can beneficially be used by a regulator or auditor to trace emissions reported by an entity for a particular product, component, or service. This beneficially enables secure and auditable emissions data reporting and aggregation, without any particular entity exposing confidential information or trade secrets.

For direct emissions measurements, a smart contract of the emission records ledger may convert inputs to normalized CO2 equivalents. The CO2 values could be calculated using different methods and units, and the ledger may be configured to convert to different standards. In some cases, for calculations, the smart contract may invoke a remote oracle to run a secure model service. For instance, the secure model service may store the model ID and the calculation parameters, and provide a hash of the inputs to the distributed ledger. This may beneficially enable a regulator or auditor to recreate calculations performed by the secure model service and verify that a recorded input results in a recorded output. As the emissions values are entered into the system, the correlation service may run the correlation for new entries and determine the chain of emissions for end products. In this manner, both interim products and end products may always have official carbon footprint documents in real time and updated dynamically.

In some cases, the emission records ledger described herein may beneficially reduce the number of middlemen involved in emissions reporting. For instance, carbon trading often involves a number of intermediaries (e.g., consultants, carbon brokers, project developers, policy makers), which contribute to significant complexity and cost. Due to the self-organizing nature of the emission records ledger, the product or service producer may simply publish their footprint to the ledger (e.g., as a plurality of discrete emission records), and this may enable the services to continuously monitor the new entries and update all interim and end products' footprints. Notably, this may be provided as a cloud service with standards-based interfaces, and thus it may be relatively easy for all sizes of customers to interact with the service. In this manner, the ledger may alleviate the need for middlemen.

Notably, existing carbon footprinting and reporting efforts often rely on customers performing their own scope 1 to scope 3 calculations, which can introduce significant work for the entity attempting to report their emissions data. Generally, scope 1 calculations relate to direct emissions measurements—e.g., based on consumption of a known amount of fossil fuels. Scope 2 calculations relate to deriving GHG emissions from consumption of electrical power, heating, and/or steam. Scope 3 calculations relate to other activities pertaining to GHG emissions, such as transportation/distribution, waste disposal, purchased materials, etc. Moreover, different entities often perform calculations in different ways, which can introduce issues with the credibility and uniformity of the calculated values. According to the techniques described herein, any activity generating carbon emissions can be recorded separately and by any entity. By leveraging the product composition graphs and the correlation services, all emissions may be mapped to the different levels of products. From there, the emission records ledger may be configured to calculate corresponding carbon footprints for each product.

The computational resources associated with implementing the emission records ledger may beneficially be relatively minimal, as each entity only calculates and/or enters into the ledger, at most, their direct portion of the emissions footprint. Once a complete composition graph is determined, the emission records ledger may be configured to estimate overall emissions of a product at any level in the supply chain, including interim products.

Calculations of emissions could in some cases be performed in the ledger by smart contracts, although additionally or alternatively could be provided as services by third parties. For instance, a standards body could provide footprint calculations services that could be connected to the ledger as oracles running on secure enclaves. Notably, this does not require a strictly “correct” interpretation of the complicated calculation models and actual calculations by any particular entity, but rather the standards and/or regulatory bodies can now provide these services and trace and attest the correctness and certification of the calculations. Furthermore, any emissions data could be traced back to its constituents in a manner that is transparently auditable by the regulator bodies.

In any case, the emission records ledger may be variously implemented and be configured to provide different types of functionality. Furthermore, the emission data records received by the emission records ledger may take any suitable form and may be provided by any variety of different emission reporting entities. Regardless, in general, the emission records ledger stores a plurality of emission data records, from which the ledger and/or other services may perform various operations to correlate and analyze the emission data records.

Returning briefly to FIG. 2, method 200 includes, at 206, receiving a request for correlated emission analytics from a requesting device corresponding to a requesting entity. As will be described in more detail below, “correlated emission analytics” refers to information output by the correlation service that specifies aggregated emissions attributable to a particular entity, event, transaction, and/or project, where the correlated emissions analytics are derived at least in part from emissions data provided to the emission records ledger by one or more emission reporting entities. In many cases, the correlated emission analytics will aggregate emissions reported by multiple different emission reporting entities. For example, correlated emission analytics for purchase of a physical product may include emissions attributable to production and transportation of the product's raw materials, assembly of the product, transportation of the finished product, emissions associated with a seller or reseller of the product, etc.

In many cases, the request for correlated emission analytics will define the specific information to be included in the correlated emission analytics. For example, the requesting entity may request emission analytics pertaining to its own purchase of a product, an ongoing project (such as building construction), total emissions over a given period of time (e.g., a financial quarter), emissions associated with an entire industry (e.g., construction, electrical production, petroleum), emissions inherited by the requesting entity from one or more other specified or unspecified entities, and/or the request for correlated emission analytics may define any other suitable scope. In some cases, the request for correlated emission analytics may specify emissions by entities other than the requesting entity—e.g., the requesting entity may be a regulator or auditor evaluating the compliance of various emission reporting entities with applicable regulations.

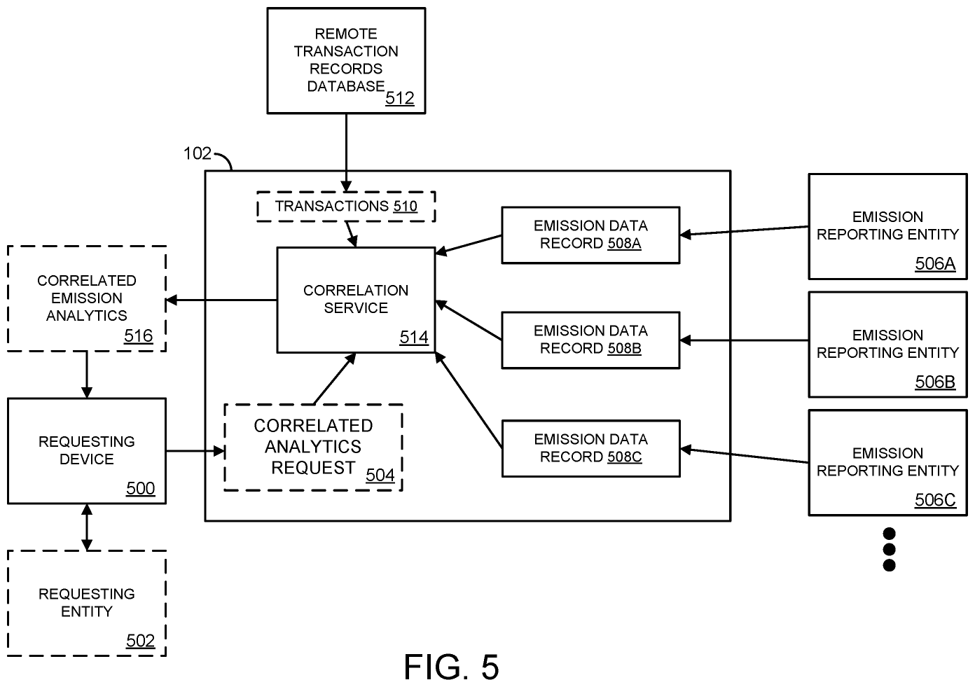

FIG. 5 schematically shows an example requesting device 500 corresponding to a requesting entity 502. The requesting device transmits a request 504 for correlated emission analytics to emission records ledger 102 (e.g., via an API). The “requesting entity” includes any party authorized to receive correlated emission analytics from the emission records ledger, and the requesting device includes any suitable computing device used by the requesting entity to transmit a request for correlated emission analytics.

As one example, correlated emission analytics may be limited only to parties that provide emission data records to the emission records ledger. Thus, the requesting entity may be any of the plurality of emission reporting entities that provide emission data records. As another example, correlated emission analytics pertaining to any particular transaction, product, project, or having any other specific focus, may be limited only to emission reporting entities providing relevant emission records. For instance, both a first emission reporting entity and a second emission reporting entity may provide emission data records pertaining to a particular transaction (e.g., a cement order). Correlated emission analytics relating to the transaction may therefore be limited to only those entities that provided relevant emission data records—e.g., the requesting entity may be the first emission reporting entity or the second emission reporting entity. As another example, the requesting entity need not be an emission reporting entity that provides emission data to the ledger, but may still receive correlated emission analytics regardless. For example, the requesting entity may be a regulator or auditor authorized to receive the correlated emission analytics.

Returning briefly to FIG. 2, method 200 includes, at 208, identifying a correlation between two or more emission data records, where the two or more emission data records may be provided by any of the plurality of different emission reporting entities. In FIG. 5, the emission records ledger receives emission data records from three different emission reporting entities 506A-C. Each of these entities respectively provide emission data records 508A-C.

Additionally, or alternatively, the emission records ledger may receive transaction data from one or more entities that do not provide emission data records. For example, in FIG. 5, the emission records ledger receives transaction data 510 from a remote transaction records database 512. As one non-limiting example, the remote transaction records database may include the petroleum industry data exchange (PIDX). The emission records ledger may receive transaction data published by the records database, and/or the computing system implementing the emission records ledger may request transaction records from the records database—e.g., via an application programming interface (API) of the records database.

In any case, a correlation service 514 associated with the emission records ledger identifies a correlation between two or more emission data records. Correlation service 514 may correlate different emissions data records in any suitable way. As one example, the correlation service may be implemented as a pre-trained machine learning (ML) model trained on labelled emission records. In this manner, the correlation service may correlate unlabeled emission records with one another and/or with associated transaction records. As another example, the correlation service may utilize a set of heuristics for matching different emissions and/or transaction records. Such records may, for example, be matched based on unique transaction identifiers, contracts uploaded by different entities, product serial numbers, common product order amounts, etc.

As one example, identifying the correlation between the two or more emission data records may include determining that the two or more emission data records relate to one or more transactions involving a first emission reporting entity and a second emission reporting entity. For example, emission data record 508A provided by emission reporting entity 506A (and/or a transaction record retrieved from database 512) may specify an amount of cement purchased by entity 506A from emission reporting entity 506B—e.g., entity 506A is a construction company, and entity 506B is a cement manufacturer. Thus, emission data record 508B may specify the amount of cement manufactured over a particular interval of time (e.g., one day), and the estimated amount of emissions associated with the cement manufacture.

The two or more emission data records may be identified and correlated by the correlation service in any suitable way. As one example, the correlation may be identified based at least in part on determining that the two or more emission data records each reference a same transaction identifier corresponding to the one or more transactions. For example, emission data records 508A and 508B may each reference the same unique transaction identifier, corresponding to a transaction involving emission reporting entities 506A and 506B.

As discussed above, each emission data record may in some cases include a plurality of standardized data fields for storing supplementary information relating to the reported emissions data. Thus, for example, the correlation service may correlate two different emission data records by determining that each record specifies the same unique transaction identifier. For instance, record 508A may specify that entity 506A purchased cement, and include the same unique transaction identifier as record 508B, specifying that entity 506B sold cement.

More particularly, the one or more transactions between the first emission reporting entity (e.g., entity 506A) and the second emission reporting entity (e.g., 506B) may relate to the purchase of a physical good by the first emission reporting entity that is facilitated by the second emission reporting entity. In such cases, the correlation may be identified based at least in part on determining that the two or more emission data records each reference a product serial number corresponding to the physical good—e.g., each stored in standardized data fields of the emission data records. Additionally, or alternatively, the correlation may be identified based at least in part on determining that the two or more emission data records each reference a same product order quantity corresponding to the physical good.

In some cases, the chain of ownership of a particular product may be tracked between several different emission reporting entities. For example, emission data records 508A, 508B, and 508C may each include data fields storing the same unique product identifier. In this manner, the correlation service may determine, for example, that the same product manufactured by entity 506B was transported by entity 506C and purchased by entity 506A. Thus, some portion of the emissions reported by entities 506B and 506C may be attributed to entity 506A and included in correlated emission analytics, as will be described in more detail below.

As used herein, a transaction may be “facilitated” by an entity if the entity is involved in any way—e.g., the entity may be a product producer, transporter, installer, reseller, or materials supplier. For instance, in one example, the second emission reporting entity may be a producer of the physical good, and the at least one emission data record provided by the second emission reporting entity may specify emissions attributed to production of the physical good. As another example, the second emission reporting entity may be a transporter of the physical good, and the at least one emission data record provided by the second emission reporting entity may specify emissions attributed to transportation of the physical good.

It will be understood, however, that the above examples are non-limiting. In general, a correlation service may derive any suitable information from any suitable number of different emissions measurements and/or transaction records provided by different emission reporting entities.

Returning briefly to FIG. 2, at 210, method 200 includes transmitting (e.g., via an API) correlated emission analytics to the requesting device based at least in part on the identified correlation. As discussed above, correlated emission analytics refers to information output by the correlation service that specifies aggregated emissions attributable to a particular entity, event, transaction, project, and/or any other suitable scope. It will be understood that the specific formatting of the correlated emission analytics may vary depending on the implementation, and that correlated emission analytics can include any suitable information in addition to what is described herein. Any suitable data structure(s), schemas, file format and/or encodings may be used to represent the correlated emission analytics.

As one example, the identified correlation may relate to purchase of a physical good by a first emission reporting entity from a second emission reporting entity, as discussed above. In such cases, the correlated emission analytics transmitted to the requesting device may specify emissions inherited by the first emission reporting entity due to the purchase of the physical good, including emissions reported by the second emission reporting entity via the at least one emission data record provided by the second emission reporting entity. For example, the correlated emission analytics may indicate the total GHG emissions attributable to a single purchase—e.g., GHG emissions corresponding to manufacture, transportation, and fabrication of cement in the construction of a new building.

To reuse the above FIG. 5 scenario where entity 506A is a construction company that purchases cement, and entity 506B is a manufacturer of the cement, the correlation service may compare the amount of cement purchased to the total amount of cement produced. In this manner, the correlation service may determine, for example, that entity 506A purchased 1% of the total cement produced by entity 506B on a given day. The correlation service may then associate 1% of the total emissions reported by entity 506B for that day to entity 506A's purchase of the cement. In other words, entity 506A inherits 1% of entity 506B's emissions on the day the cement was produced. The correlated emission analytics transmitted to the requesting entity may therefore include information indicating that entity 506A has inherited a portion of entity 506B's emissions—e.g., the relevant emissions by entity 506B may be added to the known emissions associated with the cement order.

Furthermore, it will be understood that other emissions reported by entity 506B may in some cases be attributed to other entities purchasing cement from entity 506B, and/or otherwise doing business with entity 506B. In some cases, the emission records ledger, and/or supporting services associated with the emission records ledger, may track the percentages of the emissions reported by each entity that are attributed to other emission reporting entities—e.g., 1% of entity 506B's emissions are attributed to entity 506A. In some cases, the emission records ledger may track the percentage of emissions reported by each entity that are not yet attributed to other entities, and/or are attributed to the original reporting entity. For example, 50% of entity 506B's emissions may remain attributed to entity 506B, rather than other entities doing business with entity 506B.

As another example, entity 506C may be a transportation company that transported the cement order from entity 506B to entity 506A. Emission data record 508C, provided by entity 506C, may specify the estimated GHG emissions by entity 506C over a period of time—e.g., calculated based on the amount of fuel consumed by a transportation truck during one day of operation. The correlation service may then determine, for example, that the cement purchased by entity 506A accounted for 10% of the mass transported by entity 506C on the day in question, and therefore associate 10% of the emissions reported by entity 506C on that day to entity 506A's purchase of the cement. In other words, entity 506A inherits 10% of the emissions by 506C due to transportation of the cement order.

The above example focuses primarily on correlated emission analytics pertaining to a single purchase—e.g., a cement order. It will be understood that this is non-limiting. As another example, the correlated emission analytics may indicate aggregated emissions attributable to an entire project—e.g., construction of a building, assembly of a consumer product, or installation of a utility. As another example, the correlated emission analytics may indicate total emissions attributable to a particular entity over a particular window of time—e.g., a day, a week, a month, or a year.

Correlated emission analytics may be provided to any suitable party. In one example, the correlated emission analytics may be transmitted to the requesting entity based at least in part on determining that the plurality of different emission reporting entities include the requesting entity—in other words, the requesting entity has previously provided emission data records to the emission records ledger. As another example, the correlated emission analytics may be transmitted to the requesting entity upon determining that the requesting entity has a stake in the data being requested—e.g., the requesting entity may be the purchaser of a physical good requesting analytics pertaining to total emissions associated with the purchase. Additionally, or alternatively, the correlated emission analytics may be transmitted to the requesting entity device based at least in part on determining that the requesting entity is a regulator or auditor authorized to receive the correlated emission analytics, as discussed above.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 6 schematically shows a simplified representation of a computing system 600 configured to provide any to all of the compute functionality described herein. Computing system 600 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 600 includes a logic subsystem 602 and a storage subsystem 604. Computing system 600 may optionally include a display subsystem 606, input subsystem 608, communication subsystem 610, and/or other subsystems not shown in FIG. 6.

Logic subsystem 602 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 604 includes one or more physical devices configured to temporarily and/or permanently hold computer information such as data and instructions executable by the logic subsystem. When the storage subsystem includes two or more devices, the devices may be collocated and/or remotely located. Storage subsystem 604 may include volatile, nonvolatile, dynamic, static, read/write, read-only, random-access, sequential-access, location-addressable, file-addressable, and/or content-addressable devices. Storage subsystem 604 may include removable and/or built-in devices. When the logic subsystem executes instructions, the state of storage subsystem 604 may be transformed—e.g., to hold different data.

Aspects of logic subsystem 602 and storage subsystem 604 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Correlation services and/or other computing machines described herein may be implemented using any suitable combination of state-of-the-art and/or future machine learning (ML), artificial intelligence (AI), and/or natural language processing (NLP) techniques. In particular, in some cases, a correlation service of an emission records ledger may use suitable ML and/or AI techniques in correlating two or more different emission records and/or transaction records, as discussed above.

Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

When included, display subsystem 606 may be used to present a visual representation of data held by storage subsystem 606. This visual representation may take the form of a graphical user interface (GUI). Display subsystem 606 may include one or more display devices utilizing virtually any type of technology. In some implementations, display subsystem may include one or more virtual-, augmented-, or mixed reality displays.

When included, input subsystem 608 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 610 may be configured to communicatively couple computing system 600 with one or more other computing devices. Communication subsystem 610 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a computing system comprises: a logic subsystem; and a storage subsystem holding instructions executable by the logic subsystem to: receive a plurality of emission data records over a computer network from a plurality of emission reporting devices, the plurality of emission reporting devices corresponding to a plurality of different emission reporting entities; store the plurality of emission data records in an emission records ledger; receive a request for correlated emission analytics from a requesting device corresponding to a requesting entity; identify a correlation between two or more emission data records; and transmit correlated emission analytics to the requesting device based at least in part on the identified correlation. In this example or any other example, the emission records ledger is implemented as a blockchain collectively maintained by a plurality of different computing devices. In this example or any other example, identifying the correlation between the two or more emission data records includes determining that the two or more emission data records relate to one or more transactions involving a first emission reporting entity and a second emission reporting entity. In this example or any other example, the correlation is identified based at least in part on determining that the two or more emission data records each reference a same transaction identifier corresponding to the one or more transactions. In this example or any other example, the one or more transactions relate to a purchase of a physical good by the first emission reporting entity, the purchase facilitated by the second emission reporting entity, and the two or more emission data records include at least one emission data record provided by the second emission reporting entity. In this example or any other example, the correlation is identified based at least in part on determining that the two or more emission data records each reference a product serial number corresponding to the physical good. In this example or any other example, the correlation is identified based at least in part on determining that the two or more emission data records each reference a same product order quantity corresponding to the physical good. In this example or any other example, the second emission reporting entity is a producer of the physical good, and the at least one emission data record provided by the second emission reporting entity specifies emissions attributed to production of the physical good. In this example or any other example, the second emission reporting entity is a transporter of the physical good, and the at least one emission data record provided by the second emission reporting entity specifies emissions attributed to transportation of the physical good. In this example or any other example, the correlated emission analytics specify emissions inherited by the first emission reporting entity due to the purchase of the physical good, including emissions reported by the second emission reporting entity via the at least one emission data record provided by the second emission reporting entity. In this example or any other example, an emission data record of the plurality of emission data records specifies an estimated amount of greenhouse gas (GHG) emitted by an emission reporting entity of the plurality of emission reporting entities that provided the emission data record. In this example or any other example, an emission data record of the plurality of emission data records includes activity data relating to an activity of an emission reporting entity of the plurality of emission reporting entities that resulted in emission of greenhouse gases (GHG), and wherein the correlated emission analytics are derived at least in part from the activity data. In this example or any other example, the instructions are further executable to convert the activity data into an estimated amount of GHG emissions caused by the activity of the emission reporting entity. In this example or any other example, the correlated emission analytics are transmitted to the requesting entity device based at least in part on determining that the plurality of different emission reporting entities include the requesting entity. In this example or any other example, the correlated emission analytics are transmitted to the requesting entity device based at least in part on determining that the requesting entity is a regulator or auditor authorized to receive the correlated emission analytics.

In an example, a method for emissions record analytics comprises: receiving a plurality of emission data records over a computer network from a plurality of emission reporting devices, the plurality of emission reporting devices corresponding to a plurality of different emission reporting entities; storing the plurality of emission data records in an emission records ledger; receiving a request for correlated emission analytics from a requesting device corresponding to a requesting entity; identifying a correlation between two or more emission data records; and transmitting correlated emission analytics to the requesting device based at least in part on the identified correlation. In this example or any other example, identifying the correlation between the two or more emission data records includes determining that the two or more emission data records relate to one or more transactions involving a first emission reporting entity and a second emission reporting entity. In this example or any other example, the one or more transactions relate to a purchase of a physical good by the first emission reporting entity, the purchase facilitated by the second emission reporting entity, and the two or more emission data records include at least one emission data record provided by the second emission reporting entity. In this example or any other example, the correlated emission analytics specify emissions inherited by the first emission reporting entity due to the purchase of the physical good, including emissions reported by the second emission reporting entity via the at least one emission data record provided by the second emission reporting entity.

In an example, a computing system comprises: a logic subsystem; and a storage subsystem holding instructions executable by the logic subsystem to: receive a plurality of emission data records over a computer network from a plurality of emission reporting devices, the plurality of emission reporting devices corresponding to a plurality of different emission reporting entities; store the plurality of emission data records in an emission records ledger; receive a request for correlated emission analytics from a first emission reporting device corresponding to a first emission reporting entity, the correlated emission analytics specifying emissions inherited by the first emission reporting entity due to a purchase of a physical good from a second emissions reporting entity; identify a correlation between one or more emission data records provided by the first emission reporting entity and one or more emission data records provided by the second emission reporting entity; and transmit the correlated emission analytics to the first emission reporting device based at least in part on the identified correlation.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a logic subsystem; and
a storage subsystem holding instructions executable by the logic subsystem to:
receive a plurality of emission data records over a computer network from a plurality of emission reporting devices, the plurality of emission reporting devices corresponding to a plurality of different emission reporting entities;
store the plurality of emission data records in an emission records ledger;
receive a request for correlated emission analytics from a requesting device corresponding to a requesting entity;
identify a correlation between two or more emission data records; and
transmit correlated emission analytics to the requesting device based at least in part on the identified correlation.

2. The computing system of claim 1, wherein the emission records ledger is implemented as a blockchain collectively maintained by a plurality of different computing devices.

3. The computing system of claim 1, wherein identifying the correlation between the two or more emission data records includes determining that the two or more emission data records relate to one or more transactions involving a first emission reporting entity and a second emission reporting entity.

4. The computing system of claim 3, wherein the correlation is identified based at least in part on determining that the two or more emission data records each reference a same transaction identifier corresponding to the one or more transactions.

5. The computing system of claim 3, wherein the one or more transactions relate to a purchase of a physical good by the first emission reporting entity, the purchase facilitated by the second emission reporting entity, and the two or more emission data records include at least one emission data record provided by the second emission reporting entity.

6. The computing system of claim 5, wherein the correlation is identified based at least in part on determining that the two or more emission data records each reference a product serial number corresponding to the physical good.

7. The computing system of claim 5, wherein the correlation is identified based at least in part on determining that the two or more emission data records each reference a same product order quantity corresponding to the physical good.

8. The computing system of claim 5, wherein the second emission reporting entity is a producer of the physical good, and the at least one emission data record provided by the second emission reporting entity specifies emissions attributed to production of the physical good.

9. The computing system of claim 5, wherein the second emission reporting entity is a transporter of the physical good, and the at least one emission data record provided by the second emission reporting entity specifies emissions attributed to transportation of the physical good.

10. The computing system of claim 5, wherein the correlated emission analytics specify emissions inherited by the first emission reporting entity due to the purchase of the physical good, including emissions reported by the second emission reporting entity via the at least one emission data record provided by the second emission reporting entity.

11. The computing system of claim 1, wherein an emission data record of the plurality of emission data records specifies an estimated amount of greenhouse gas (GHG) emitted by an emission reporting entity of the plurality of emission reporting entities that provided the emission data record.

12. The computing system of claim 1, wherein an emission data record of the plurality of emission data records includes activity data relating to an activity of an emission reporting entity of the plurality of emission reporting entities that resulted in emission of greenhouse gases (GHG), and wherein the correlated emission analytics are derived at least in part from the activity data.

13. The computing system of claim 12, wherein the instructions are further executable to convert the activity data into an estimated amount of GHG emissions caused by the activity of the emission reporting entity.

14. The computing system of claim 1, wherein the correlated emission analytics are transmitted to the requesting entity device based at least in part on determining that the plurality of different emission reporting entities include the requesting entity.

15. The computing system of claim 1, wherein the correlated emission analytics are transmitted to the requesting entity device based at least in part on determining that the requesting entity is a regulator or auditor authorized to receive the correlated emission analytics.

16. A method for emissions records analytics, the method comprising:
receiving a plurality of emission data records over a computer network from a plurality of emission reporting devices, the plurality of emission reporting devices corresponding to a plurality of different emission reporting entities;
storing the plurality of emission data records in an emission records ledger;
receiving a request for correlated emission analytics from a requesting device corresponding to a requesting entity;
identifying a correlation between two or more emission data records; and
transmitting correlated emission analytics to the requesting device based at least in part on the identified correlation.

17. The method of claim 16, wherein identifying the correlation between the two or more emission data records includes determining that the two or more emission data records relate to one or more transactions involving a first emission reporting entity and a second emission reporting entity.

18. The method of claim 17, wherein the one or more transactions relate to a purchase of a physical good by the first emission reporting entity, the purchase facilitated by the second emission reporting entity, and the two or more emission data records include at least one emission data record provided by the second emission reporting entity.

19. The method of claim 18, wherein the correlated emission analytics specify emissions inherited by the first emission reporting entity due to the purchase of the physical good, including emissions reported by the second emission reporting entity via the at least one emission data record provided by the second emission reporting entity.

20. A computing system, comprising:
a logic subsystem; and
a storage subsystem holding instructions executable by the logic subsystem to:
receive a plurality of emission data records over a computer network from a plurality of emission reporting devices, the plurality of emission reporting devices corresponding to a plurality of different emission reporting entities;
store the plurality of emission data records in an emission records ledger;
receive a request for correlated emission analytics from a first emission reporting device corresponding to a first emission reporting entity, the correlated emission analytics specifying emissions inherited by the first emission reporting entity due to a purchase of a physical good from a second emissions reporting entity;
identify a correlation between one or more emission data records provided by the first emission reporting entity and one or more emission data records provided by the second emission reporting entity; and
transmit the correlated emission analytics to the first emission reporting device based at least in part on the identified correlation.
